(19) United States
(12) Patent Application Publication
(10) Pub. No.: US 2008/0313859 A1
(43) Pub. Date: Dec. 25, 2008

(54) Soft handle having double layers of soft skins

(76) Inventor: Hsia Hui Chen, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/812,389

(22) Filed: Jun. 19, 2007

(51) Int. Cl. B25G 1/10

(52) U.S. Cl. 16/430; 16/431

(57) ABSTRACT

A soft handle having double layers of soft skins includes a middle rod, a supporting flange, and a top cap. The inner skin connects the middle rod to be received in the outer skin. The supporting flange and the cap are used to connect the skins and the rod to become a soft handle, which can prevent from leakage of liquid in the skins. The soft handle is capable of being applied on many objects that provides a soft tactile feeling. The improved effect is obvious.

### BACKGROUND OF THE INVENTION

In order to provide a soft handle for easy and comfortable use, there are several designs in prior art and they can offer a certain effect. The known soft handles include somehow various connecting structures but all include a common merit that has a shell having a single soft skin to connect a middle rod and injects liquid therebetween. When they are used in normal, there will be no problem. But when a twist force occurs in accident, the soft skin is easily released from the rod at connecting end since the connection is not so enough in all conventional structures. At this moment, liquid will be leaked and the handle is then out of work. This drawback falls in all prior soft handle.

The present invention is to provide a handle, which includes a shell with two layers of soft skins that keeps a promised connecting to prevent from leakage of inner liquid. Now, accompanying with drawings, the character and structure of the present invention will be disclosed as following.

### BRIEF DESCRIPTION OF THE DRAWINGS

FIG. 1 is an exploded perspective view showing a soft handle according to the present invention.

FIG. 2 is a cross-sectional plan view showing a shell including double layers of soft skins in FIG. 1

FIG. 3 is a view of FIG. 2 after connecting a middle rod.

FIG. 4 is an assembled cross-sectional plan view of FIG. 1.

FIG. 5 is a perspective view of FIG. 4.

FIGS. 6 and 7 are views of FIG. 5 when connecting a lower cap as an embodiment according to the present invention.

FIG. 8 is a cross-sectional plan view of FIG. 7.

FIG. 9 is an exploded perspective view showing a modified embodiment of a soft handle according to the present invention.

FIG. 10 is a cross-sectional plan view showing a modified shell including double layers of soft skins in FIG. 9

FIG. 11 is a view of FIG. 10 after connecting a middle rod.

FIG. 12 is an assembled cross-sectional plan view of FIG. 9.

FIG. 13 is a view of FIG. 12 when connecting a lower cap as another embodiment according to the present invention.

FIGS. 14 and 15 are views showing applications connecting with the soft handle according to the present invention.

### DETAILED DESCRIPTION OF THE PREFERRED EMBODIMENT

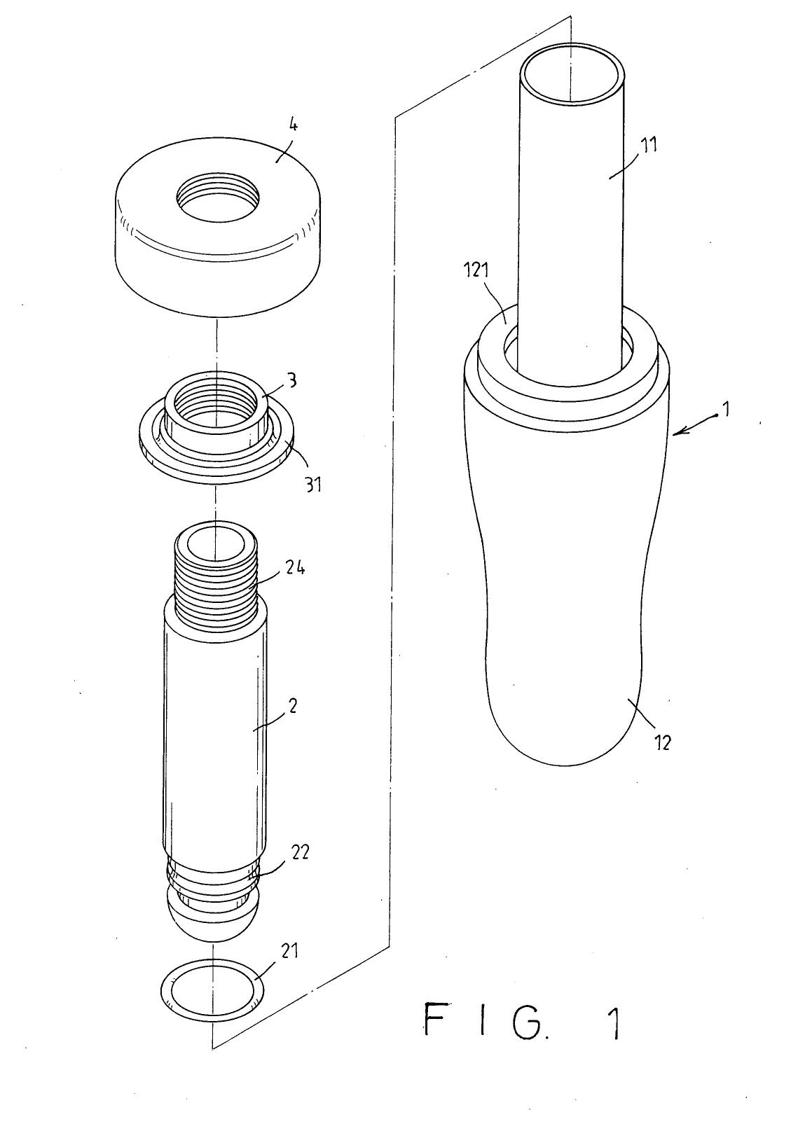

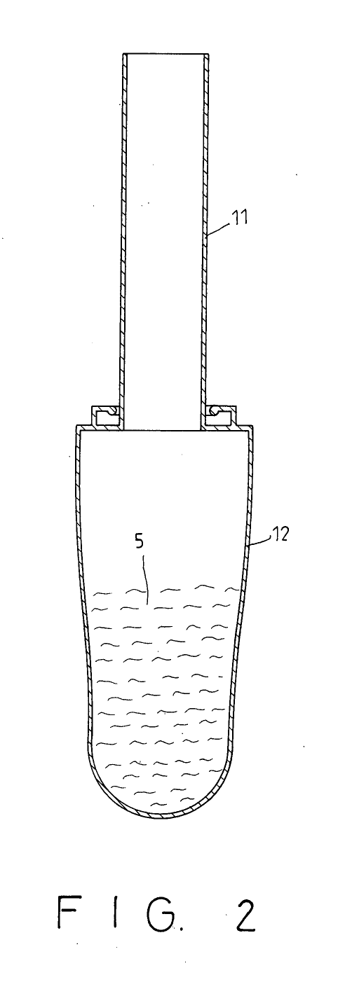

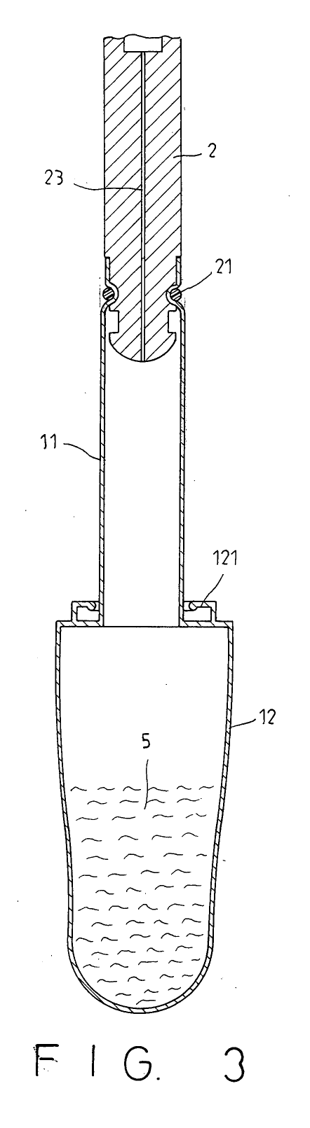

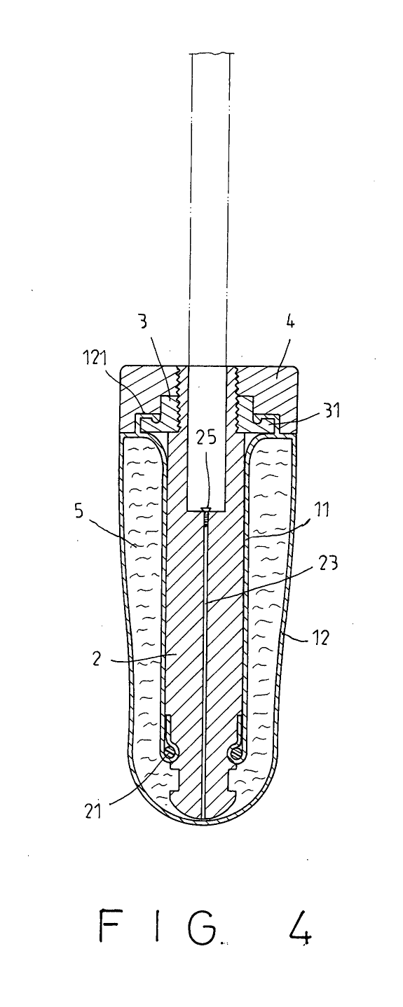

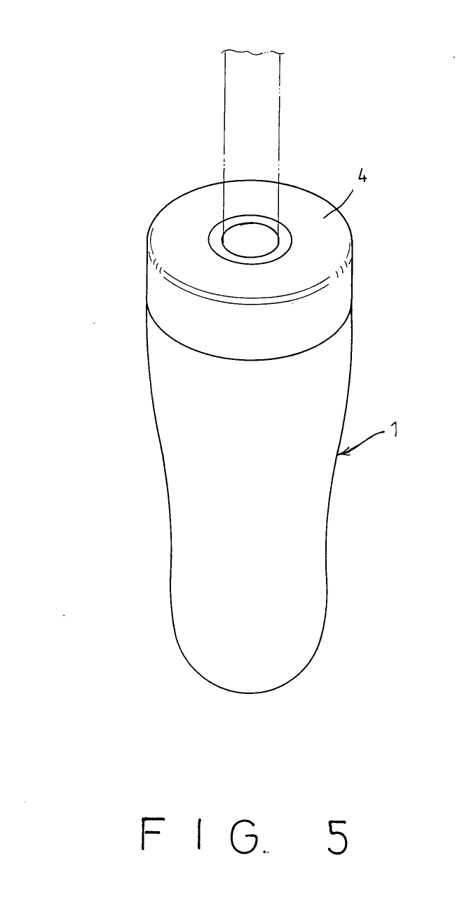

Please refer to FIG. 1 first; the present invention relates to a soft handle, which includes a shell (1) having two layers of soft skins (11), (12), a middle rod (2), a supporting flange (3), and a top cap (4). The shell (1) is injected with liquid (5) therein, as shown in FIG. 2. The middle rod (2) has its lower end connect with top end of the inner soft skin (11) of the shell (1) by use of an O-ring (21) to loop around an annual groove (22) on the rod (2), as in FIG. 3. The middle rod (2) has a top thread end (24) and an axial hole (23). The supporting flange (3) and the top cap (4) are threaded with the thread end (24) of the rod (2). Referring to FIG. 4, the rod (2) and the inner skin (11) are insert into the outer skin (12) and circumstances (31) of the flange (3) will be engaged with rims (121) extended from top end of the outer skin (12). The top cap (4) covers thereon and connects every piece to become a single body and a screw (25) is provided to seal the hole (23) that completes the soft handle according to the present invention, as shown in FIG. 5.

Under above assembly, since there are double layers provided on the handle of the present invention, any leakage of liquid will not happen when a rotated force occurs. The shell (1) will not release from the supporting flange (3) and the middle rod (2). It obtains improvement and utilization. And the connection of each parts of the invention is more convenient than prior art.

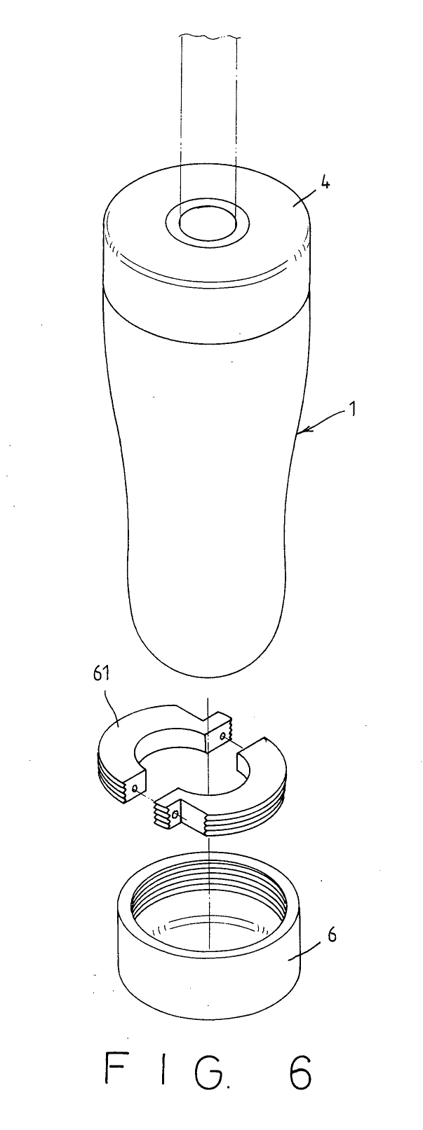

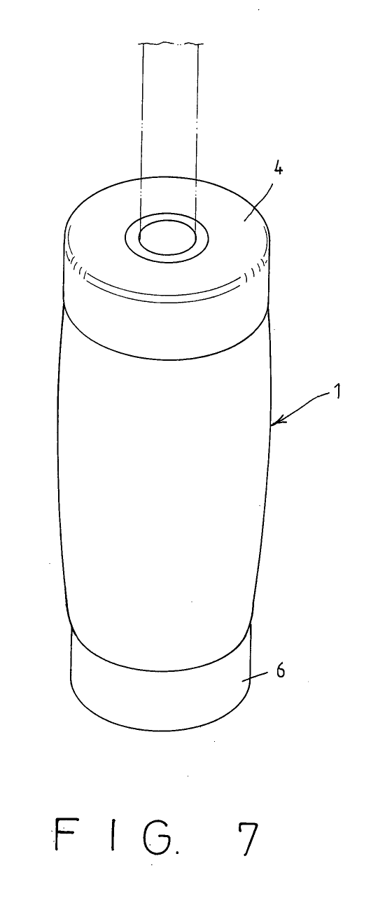

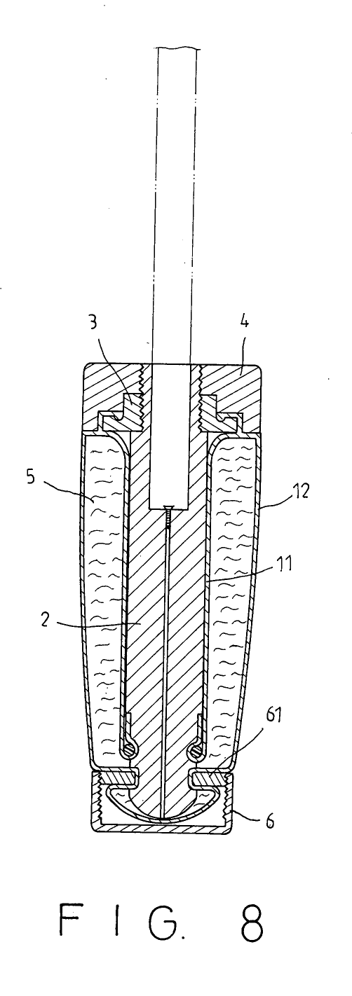

Referring to FIG. 6 to 8, a lower supporting flange (61) and a lower cap (6) can be connected to the soft handle according to the present invention. The lower supporting flange (61) includes a pair of semi-circular pieces to loop around a related convex portion on the rod (2) and the lower cap (6) is threaded outside to form a soft handle having two rigid ends and a soft central body.

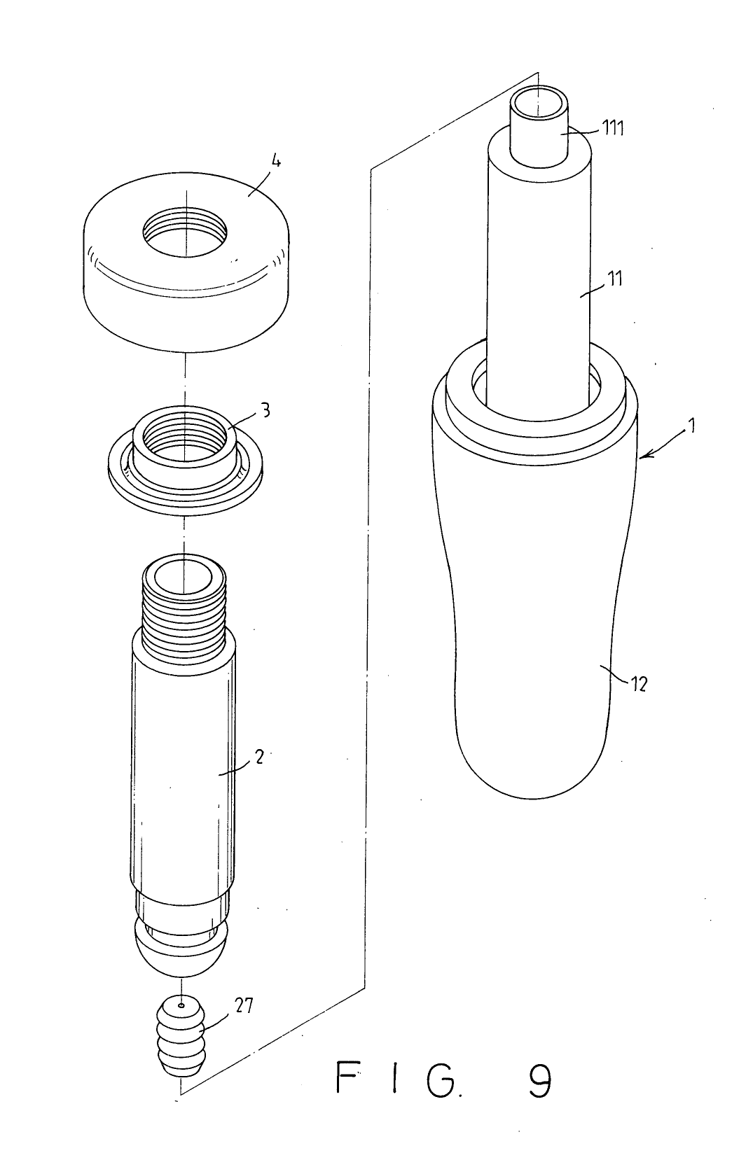

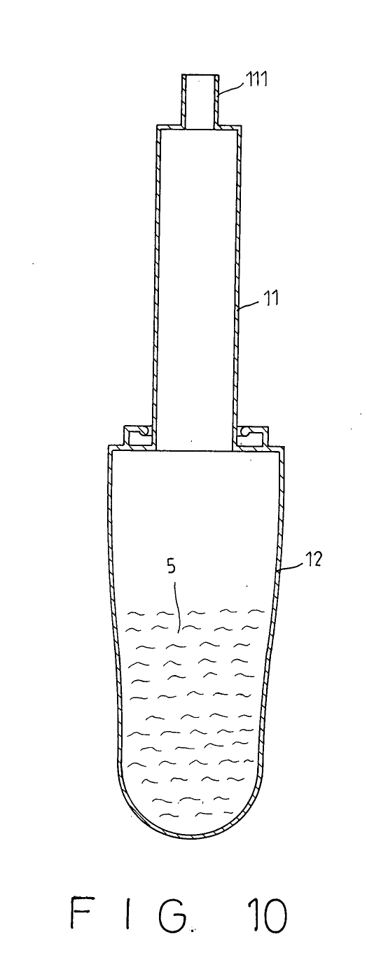

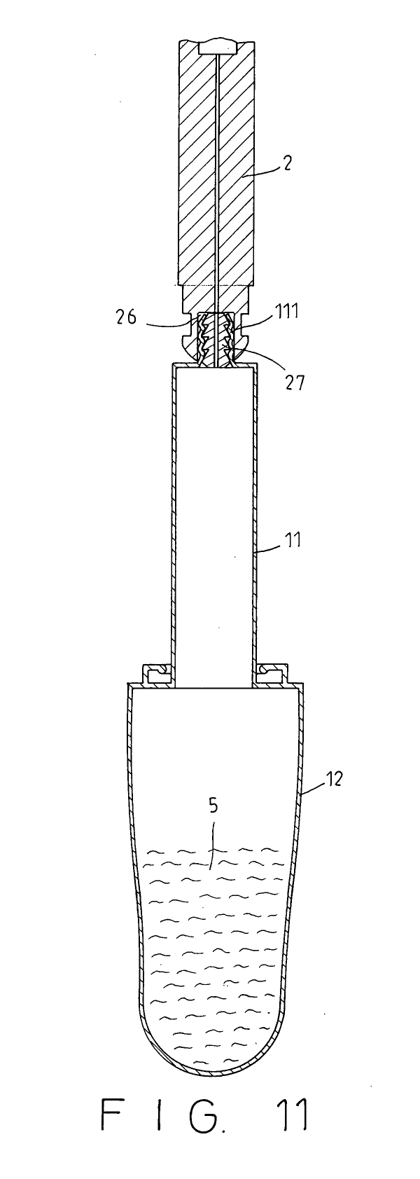

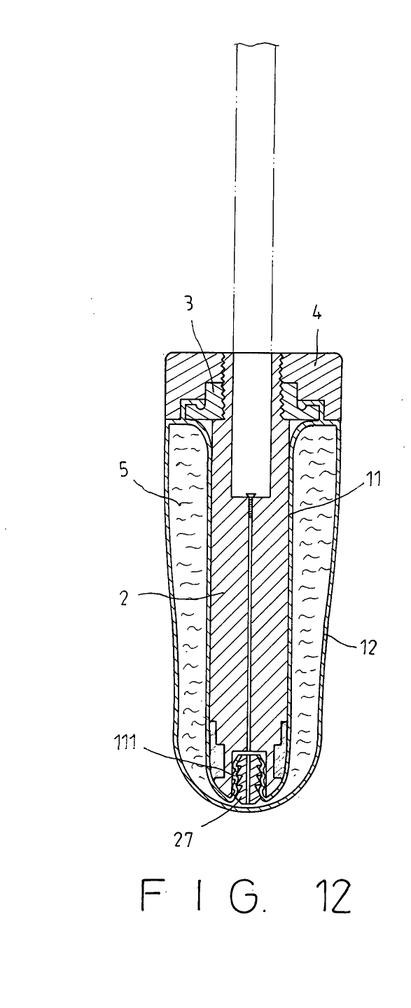

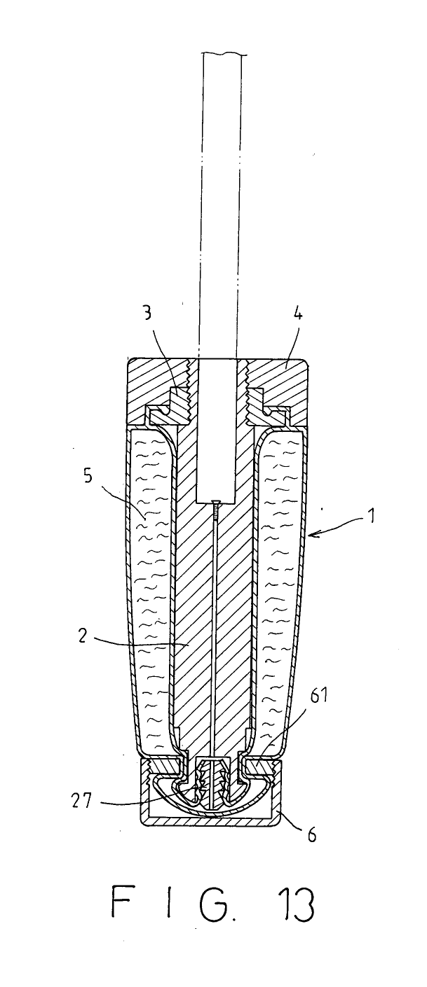

As shown in FIG. 9 to 12, it shows a modified embodiment under the same invented spirit as this invention. In this embodiment, a sealing skin (111) is formed on the inner skin (11) of the shell (1). A connecting aperture (26) is provided at lower end of the rod (2) for receiving a connector (27), which has a waved surface. When the rod (2) connects the inner skin (11), the sealing skin (111) will be engaged in secure in the aperture (26) by the connector (27). By the same assembling procedures as above, it becomes a modified connection and provides a soft handle with a similar effect. FIG. 13 shows a perspective view of this modified embodiment after connecting the lower supporting flange (61) and the lower cap (6).

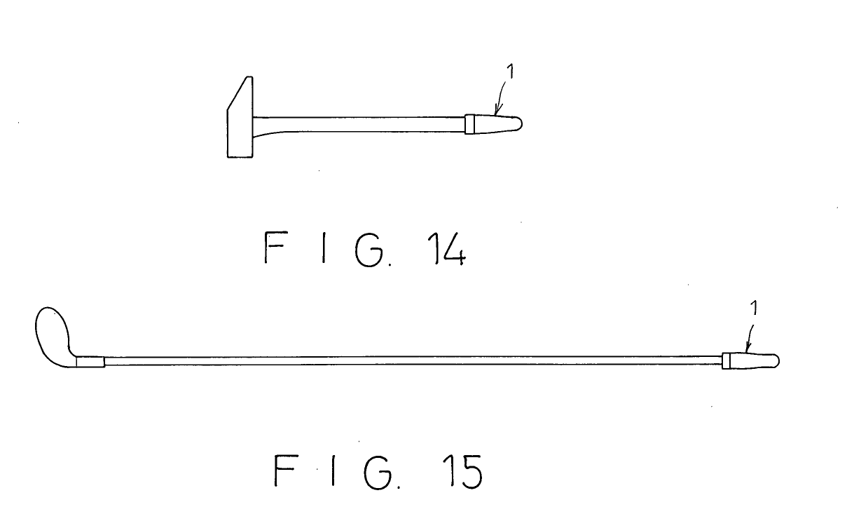

Referring to FIGS. 14 and 15, the soft handle provided by the present invention can be used on a hammer or a golf club that obtains an excellent tactile feeling. Accordingly, the present invention obtains improvement and effects and should be allowed for a patent. And it is to be understood that the aforesaid embodiment is just an exemplary and is not to limit the scope of the present invention.

I claim:

1. A soft handle having double layers of soft skins and including a middle rod, a supporting flange, and a top cap, wherein the shell being injected with liquid, the middle rod having its lower end connect with top end of the inner soft skin of the shell by use of an O-ring to loop around an annual groove on the rod, the middle rod having a top thread end and an axial hole, the supporting flange and the top cap being threaded with the thread end of the rod, while the rod and the inner skin are insert into the outer skin and circumstances of the flange will be engaged with rims extended from top end of the outer skin, and the top cap covers thereon that connects all pieces to become a single body and a screw is provided to seal the hole.

2. The soft handle having double layers of soft skins as claimed in claim 1, wherein a sealing skin is formed on the inner skin of the shell, a connecting aperture is provided at lower end of the rod for receiving a connector, which has a waved surface, and the rod connects the inner skin for the sealing skin being engaged in secure in the aperture by the connector.

3. The soft handle having double layers of soft skins as claimed in claim 1, wherein a lower supporting flange and a lower cap are connected to the soft handle; the lower supporting flange includes a pair of semi-circular pieces to loop around a related convex portion on the rod and the lower cap is threaded outside to form a soft handle having two rigid ends and a soft central body.
